(19) United States
(12) Patent Application Publication
(10) Pub. No.: US 2020/0150058 A1
(43) Pub. Date: May 14, 2020

(54) Recycling device for cutting waste of numerically controlled machine tool

(71) Applicant: Danyang Mao, Quzhou City (CN)

(72) Inventor: Danyang Mao, Quzhou City (CN)

(21) Appl. No.: 16/732,358

(22) Filed: Jan. 2, 2020

(30) Foreign Application Priority Data
Sep. 28, 2019 (CN) 201910928482X

(51) Int. Cl. G01N 23/04

(52) U.S. Cl. CPC G01N 23/04

(57) ABSTRACT

The invention discloses a numerical control machine tool cutting waste recycling device, which comprises a machine tool base. The machine tool base is provided with a base cavity with an opening facing upward, a collection device is provided at the opening of the base cavity, and a diversion cavity is provided with A vibrating device located below the collecting device, a waste liquid recovery device for recovering cutting waste liquid located below the diversion cavity is provided in the base cavity, and a base liquid is provided in the base cavity. The power device on the right side of the flow cavity is used to provide power for the entire device. The base cavity is provided with a compression device located on the right side of the power device. The compression device is used to compress the cutting waste. Drive the up and down vibration of the recovery tank to reduce the clogging probability of the filter of the recovery tank, thereby reducing the maintenance times of the recovery device. The invention avoids affecting the normal processing of the machine tool through the recovery tank structure provided on the base of the machine tool, and can automatically recover and process the processing waste.

### CROSS-REFERENCES TO RELATED APPLICATIONS

The present application claims priority from Chinese application No. 201910928482X filed on Sep. 28, 2019 which is hereby incorporated by reference in its entirety.

### FIELD OF TECHNOLOGY

The invention relates to the technical field of machine tool cutting waste recovery, and in particular relates to a recycling device for cutting waste of numerically controlled machine tool.

### TECHNICAL FIELD

Machine tools produce a large amount of waste materials during cutting production. Waste materials include cutting waste and cutting waste. Generally, these waste materials will be discarded after being cleaned, especially for smaller waste materials. Most recycling devices can only perform single item recycling, and cannot simultaneously recover cutting waste and cutting waste liquid, which makes the recycling effect poor. At the same time, most current recycling devices require a recycling mechanism on the machine tool table to make the recycling mechanism installation layout. It is difficult, and it will affect the normal processing of the machine tool to a certain extent, so it cannot be widely used. The invention illustrates a device that can solve the above problems.

### CONTENT OF THE INVENTION

Technical problem: Most of the current recycling devices need to have a recycling mechanism on the machine tool table, which will affect the normal processing of the machine tool, so it cannot be widely used.

In order to solve the above problems, a numerical control machine tool cutting waste recovery device is designed in this example. The numerical control machine tool cutting waste recovery device in this example includes a machine tool base, and the machine tool base is provided with a base cavity with an opening facing upward. A collection device is provided at the opening of the base cavity, and the collection device includes a diversion cavity provided in the base cavity and opening upward, a lifting block slidably connected to the inner wall on the right side of the diversion cavity, and disposed on the right side of the diversion cavity. A lifting cavity in a lifting block, an impeller fixedly connected to an inner wall on the right side of the lifting cavity, a rotating shaft connected to the impeller and extending to the left outside the end surface of the lifting block, and fixedly connected to the rotating shaft A collection box located above and in the diversion cavity, and using the impeller to drive the rotating shaft to rotate, so that the collection box rotates to dump cutting waste into the diversion cavity, inside the diversion cavity A vibrating device is provided on the lower side of the collecting device, and the vibrating device includes a secondary impeller fixedly connected to the inner wall on the rear side of the guide cavity, and the secondary impeller is located on the lower side of the lifting block A crank shaft that is rotationally connected in the auxiliary impeller and extends forward into the guide cavity, a crank that is fixedly connected to the crank shaft and is located in the guide cavity, and is hinged on the crank A connecting rod, a fixed block fixedly connected to the lower end surface of the lifting block and articulated with the connecting rod, and using the auxiliary impeller to drive the crank shaft and the crank to rotate, so that the fixed block is driven The lifting block moves up and down to realize the vibration of the collecting box up and down to fully remove the cutting waste on the collecting box. The base cavity is provided with a waste for recovering the cutting waste liquid located on the lower side of the diversion cavity. In the liquid recovery device, a power device for powering the entire device is provided in the base cavity on the right side of the diversion cavity, and a compression device on the right side of the power device is provided in the base cavity. The compression device is used for compressing cutting waste.

Preferably, the collection box is used for storing cutting waste and the opening is upward, and the lower end surface of the collection box is a wire mesh structure, and the cutting waste liquid can pass through the collection box, and the upper end surface of the machine tool base is provided with Machine body.

Wherein, the collecting device further includes a cam fixedly connected to the rotating shaft, and a limit rod that can abut the cam is fixedly connected to the left inner wall of the lifting cavity, and the cam rotates to one hundred and eighty Abutting with the limit lever, so that the collection box can only rotate one hundred and eighty degrees, a slider is slidably connected to the left inner wall of the diversion cavity, and the slider and the rotating shaft Rotating connection, two left and right symmetrical baffles are fixedly connected to the upper end surface of the collection box.

Preferably, the baffle is used to prevent cutting waste from falling into the diversion cavity through the rotary connection of the rotating shaft.

Wherein, the vibration device further includes a valve body fixedly connected to the lower end surface of the lifting block, and the valve body is slidably connected with the inner wall on the rear side of the flow guiding cavity. A left valve body cavity is connected with an air pipe between the valve body cavity and the impeller, an air pipe is connected between the valve body cavity and the auxiliary impeller, and a stop block is slidably connected in the valve body cavity. The cut-off block can make the air duct and the gas pipe not communicate with each other, the cut-off block can block the left opening of the valve body cavity, and make the valve body cavity and the flow cavity non-communication. A driven rod extending upward into the lifting cavity is fixedly connected to the upper end surface of the valve body cavity, and a pushing block abutting the cam is fixedly connected to the driven rod, and the pushing block and the lifting cavity are fixedly connected to the driven rod. A compression spring is connected between the lower inner walls, and an exhaust pipe communicating with the auxiliary impeller is fixedly connected to the lower end surface of the auxiliary impeller.

Preferably, the pushing block and the cam are always in abutting state under the action of the compression spring elastic force, and the blocking block blocks the communication block when the cutoff block communicates the gas pipe with the air duct. The left side of the valve body cavity is opened, and the cut-off block does not block the left side opening of the valve body cavity, that is, when the valve body cavity is in communication with the flow guiding cavity, the gas delivery pipe is not in communication with the air guiding pipe.

Wherein, the waste liquid recovery device comprises a waste liquid tank fixedly connected to the inner wall of the lower side of the base cavity and located below the diversion cavity. The waste liquid tank is provided with a waste liquid cavity, and the waste liquid A water valve is provided on the left end surface of the cavity, and a water pipe is connected between the water valve and an external waste liquid processing equipment, and a connection pipe is connected between the waste liquid cavity and the diversion cavity. A cylinder is fixedly connected to the inner wall of the rear side, and an air cavity is provided in the cylinder. A slide plug is slidably connected to the air cavity. A push rod extending upward into the connecting pipe is fixedly connected to an upper end surface of the slide plug. A sealing block located in the connecting pipe is fixedly connected to the push rod, and the sealing block can block the connection between the diversion cavity and the connecting pipe, and the sliding plug is connected to the air cavity A return spring is connected between the side inner walls.

Wherein, the power device includes a power cavity disposed in the base cavity and located on the right side of the diversion cavity, and a forwardly extending motor shaft is rotatably connected to the inner wall of the rear side of the power cavity, and the motor shaft A motor is fixedly connected to the inner wall on the rear side of the power chamber. An air pump is fixedly connected to the inner wall on the front side of the power chamber. An electromagnet is fixedly connected to the rear end surface of the air pump. A gas pump shaft extending backward into the power cavity, and the gas pump shaft penetrates the electromagnet, a spline wheel is fixedly connected to the air pump shaft, and a spline cylinder is splined to the spline wheel. A cavity is positioned in the front side of the spline cylinder, a secondary compression spring is connected between the spline cylinder and the electromagnet, and a rear end surface of the spline cylinder is fixedly connected. The bevel gear located on the back side of the spline wheel, the motor shaft extends into the spline cylinder and is connected with the bevel gear feather key, and an air pipe is connected between the air pump and the impeller. A secondary air pipe is connected between the air pump and the air cavity.

Wherein, the compression device includes a boss fixedly connected to the inner wall of the rear side of the power chamber and located on the right side of the motor, and the left end surface of the boss is rotatably connected to the left and right extensions and extends to the right to the protrusion. A gear shaft outside the end surface of the table, a secondary bevel gear that can be meshed with the bevel gear is fixedly connected to the gear shaft, and the secondary bevel gear is located on the left side of the boss and on the inner wall on the rear side of the power cavity A reduction box located on the right side of the boss is fixedly connected, the gear shaft extends into the reduction box and can drive the reduction box to work, and the reduction box is rotatably connected to the power chamber which extends to the right. An internal reduction shaft, and the reduction shaft is located on the front side of the gear shaft, and the gear box torque can be increased by decelerating the reduction gear box, thereby increasing the pressing force of the rack and the pressure plate and improving compression Rate, a gear located in the power cavity is fixedly connected to the reduction shaft, a rack gear meshed with the gear is slidably connected to the right inner wall of the power cavity, and the base cavity is provided with the gear located in the power cavity. The lower side of the power chamber and The compression chamber with the flow cavity communicating, and the compression chamber opening is facing right, a box door is rotatably connected to the right opening of the compression chamber, the rack extends downward into the compression chamber, and the rack is fixed on the rack. A pressure plate located in the compression cavity is connected.

The beneficial effect of the present invention is that the recovery device of the present invention adopts a recovery tank structure and is arranged on the base of the machine tool, which prevents the recovery mechanism from being installed on the machine tool table and affects the normal processing of the machine tool. It is filtered and stored in the waste liquid tank. After the machine tool finishes processing, the rotating mechanism can get the recovery tank to rotate 180 degrees, convey the cutting waste in the recovery tank to the compression chamber, and simultaneously drive the recovery tank to vibrate up and down through the vibration mechanism. The cutting waste stuck on the recovery tank is poured into the compression cavity, reducing the probability of clogging the filter of the recovery tank, thereby reducing the number of maintenance of the recovery device, and then the compression mechanism compresses the cutting waste to complete a recovery process, so The invention avoids affecting the normal processing of the machine tool through the structure of the recovery groove provided on the base of the machine tool, and can realize automatic recovery and processing of processing waste.

### BRIEF DESCRIPTION OF THE DRAWINGS

For ease of description, the present invention is described in detail by the following specific embodiments and the accompanying drawings.

FIG. 1 is a schematic diagram of the overall structure of a cutting waste recycling device of a numerical control machine tool according to the present invention;

FIG. 2 is a schematic structural diagram of the direction “A-A” of FIG. 1;

FIG. 3 is an enlarged schematic view of the structure at “B” in FIG. 1;

FIG. 4 is an enlarged schematic view of the structure at “C” in FIG. 1;

FIG. 5 is a schematic structural diagram of the “D-D” direction of FIG. 3.

### DETAILED DESCRIPTION OF THE INVENTION

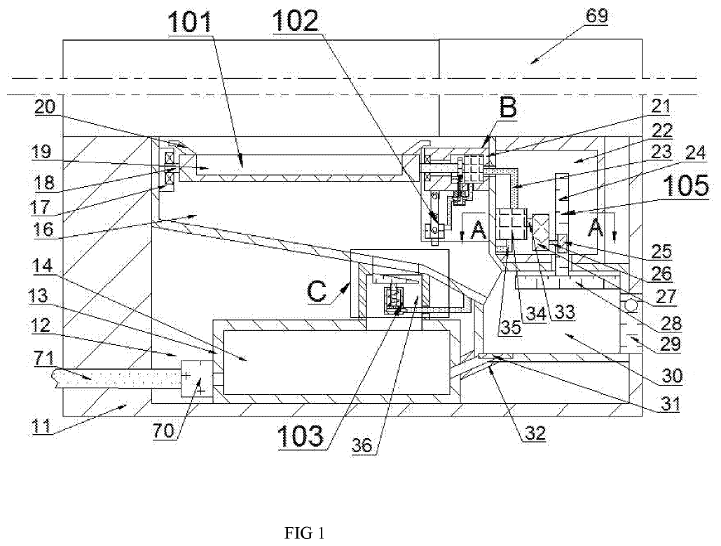

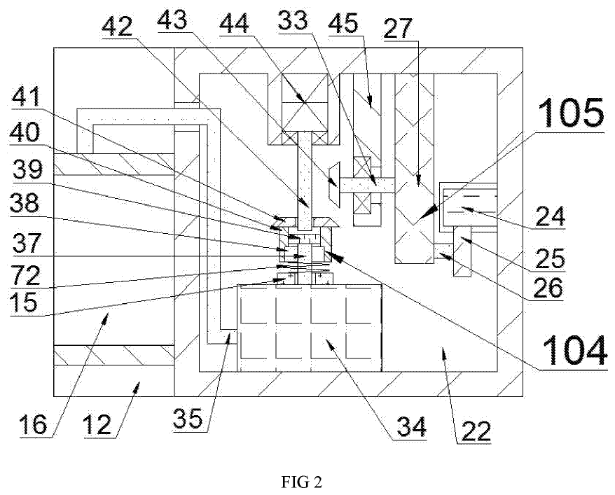

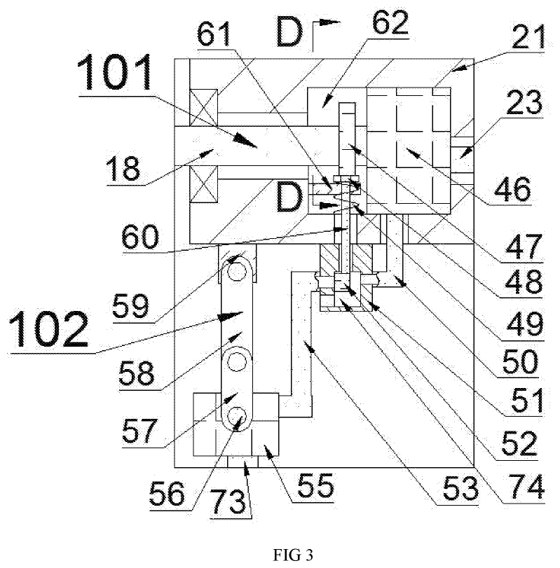

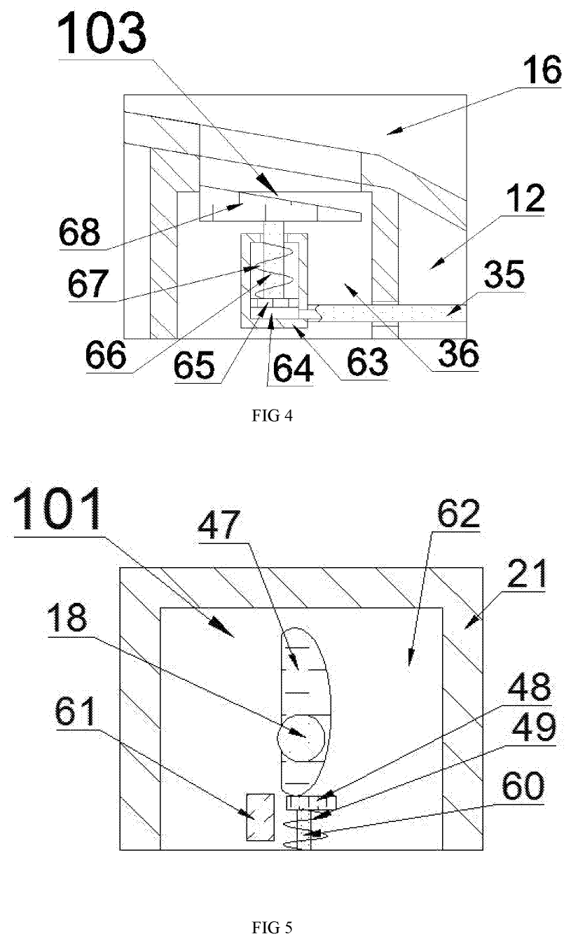

The present invention is described in detail below with reference to FIGS. 1 to 5. For convenience of description, the orientation described below is defined as follows: the up-down, left-right, front-back direction described below is consistent with the up-down, left-right, front-back direction of the projection relationship of FIG.

The invention relates to a numerical control machine tool cutting waste recycling device, which is mainly used for machine tool cutting waste recycling. The invention will be further described below with reference to the accompanying drawings of the invention:

A cutting waste recycling device for a numerically-controlled machine tool according to the present invention includes a machine tool base 11. The machine tool base 11 is provided with a base cavity 12 with an opening facing upward, and a collection device 101 is provided at the opening of the base cavity 12. The collecting device 101 includes a guide cavity 16 provided in the base cavity 12 and opening upward, a lifting block 21 slidably connected to an inner wall on the right side of the guiding cavity 16, and a lifting device provided in the lifting block 21. A cavity 62, an impeller 46 fixedly connected to the right inner wall of the lifting cavity 62, a rotating shaft 18 rotationally connected to the impeller 46 and extending to the left outside the end surface of the lifting block 21, fixedly connected to the A collection box 19 on the rotating shaft 18 and located in the guide cavity 16, and the impeller 46 is used to drive the rotating shaft 18 to rotate, so as to realize the rotation of the collection box 19 and dump cutting waste to the guide cavity 16 Inside, the guide chamber 16 is provided with a vibration device 102 located below the collection device 101, and the vibration device 102 includes an auxiliary impeller 55 fixedly connected to the inner wall on the rear side of the guide chamber 16, and The auxiliary impeller 55 is located below the lifting block 21, and rotates A crank shaft 56 connected in the auxiliary impeller 55 and extending forward into the guide cavity 16, a crank 57 fixedly connected to the crank shaft 56 and located in the guide cavity 16, hinged on A connecting rod 58 on the crank 57, a fixing block 59 fixedly connected to the lower end surface of the lifting block 21 and articulated with the connecting rod 58, and using the auxiliary impeller 55 to drive the crank shaft 56 Rotation of the crank 57 causes the fixed block 59 to drive the lifting block 21 to move up and down, so that the collecting box 19 can vibrate up and down to fully remove the cutting waste on the collecting box 19. The base cavity 12 is provided inside A waste liquid recovery device 103 for recovering cutting waste liquid is located on the lower side of the guide cavity 16, and the base cavity 12 is provided with a power supply for powering the entire device on the right side of the guide cavity 16. The power device 104 is provided with a compression device 105 located on the right side of the power device 104 in the base cavity 12. The compression device 105 is used to compress the cutting waste.

Beneficially, the collection box 19 is used to store cutting waste and has an opening facing upward, and the lower end surface of the collection box 19 is a wire mesh structure, and cutting waste liquid can pass through the collection box 19, and the upper side of the machine tool base 11 A machine body 69 is provided on the end surface.

According to the embodiment, the collection device 101 will be described in detail below. The collection device 101 further includes a cam 47 fixedly connected to the rotating shaft 18, and a left inner wall of the lifting cavity 62 is fixedly connected with the cam 47. The abutment of the limiting lever 61, the cam 47 abuts with the limiting lever 61 after turning to 180 degrees, so that the collection box 19 can only rotate 180 degrees, and the flow guide A slider 17 is slidably connected to the inner wall on the left side of the cavity 16, and the slider 17 is rotatably connected to the rotating shaft 18. Two upper and lower symmetrical baffles 20 are fixedly connected to the upper end surface of the collection box 19. The impeller 46 drives the rotating shaft 18 to rotate, so that the collection box 19 is rotated to pour the cutting waste into the flow guiding cavity 16.

Advantageously, the baffle plate 20 is used to prevent cutting waste from falling into the flow guiding cavity 16 through the rotational connection of the rotating shaft 18.

According to the embodiment, the vibration device 102 will be described in detail below. The vibration device 102 further includes a valve body 51 fixedly connected to the lower end surface of the lifting block 21, and the valve body 51 and the flow guiding chamber 16 The rear inner wall is slidingly connected. The valve body 51 is provided with a valve body cavity 74 opening to the left. The valve body cavity 74 and the impeller 46 are connected to each other through an air pipe 50. The valve body cavity 74 and An air duct 53 is connected to the auxiliary impellers 55, and a cut-off block 52 is slidably connected to the valve body cavity 74. The cut-off block 52 can make the air duct 53 and the air duct 50 not communicate with each other. The blocking block 52 can block the opening on the left side of the valve body cavity 74 so that the valve body cavity 74 is not in communication with the diversion cavity 16, and an upper end surface of the valve body cavity 74 is fixedly connected to extend upward to the lift The driven rod 60 in the cavity 62 is fixedly connected with a pushing block 48 abutting the cam 47, and a compression is connected between the pushing block 48 and the lower inner wall of the lifting cavity 62. A spring 49, and an exhaust pipe 73 communicating with the auxiliary impeller 55 is fixedly connected to the lower end surface of the auxiliary impeller 55. The cam 47 rotates one hundred and eighty degrees and pushes the push block 48 and the cut-off block 52 downward, so that the air pipe 50 and the air pipe 53 are communicated, so that the airflow in the turbine 46 When it flows into the auxiliary impeller 55, it drives the auxiliary impeller 55 to work, and realizes the vertical vibration movement.

Beneficially, under the action of the elastic force of the compression spring 49, the push block 48 and the cam 47 are always in abutting state, and the cut-off block 52 makes the air pipe 50 communicate with the air pipe 53. The blocking block 52 blocks the left opening of the valve body cavity 74, and the blocking block 52 does not block the left opening of the valve body cavity 74, that is, when the valve body cavity 74 communicates with the flow guiding cavity 16, the The air duct 50 is not in communication with the air duct 53.

According to the embodiment, the waste liquid recovery device 103 is described in detail below. The waste liquid recovery device 103 includes a waste liquid tank 13 fixedly connected to the inner wall of the lower side of the base cavity 12 and located below the flow guiding cavity 16. The waste liquid tank 13 is provided with a waste liquid chamber 14, and a left side end surface of the waste liquid chamber 14 is provided with a water valve 70. A water pipe 71 is connected between the water valve 70 and an external waste liquid processing equipment. A connecting pipe 36 is connected between the waste liquid chamber 14 and the flow guiding chamber 16. A cylinder 63 is fixedly connected to the inner wall of the rear side of the connecting pipe 36, and an air chamber 64 is provided in the cylinder 63. A sliding plug 65 is slidably connected to the air cavity 64, and a push rod 66 extending up to the connecting pipe 36 is fixedly connected to an upper end surface of the sliding plug 65, and the push rod 66 is fixedly connected to the connecting rod 36. A sealing block 68 in the tube 36, and the sealing block 68 can block the communication between the diversion cavity 16 and the connecting tube 36, and the sliding plug 65 is connected to the upper inner wall of the air cavity 64. There is a return spring 67, which drives the sealing block 68 to move upward through the sliding plug 65, so that the sealing block 68 seals the communication chamber 16 and the connecting pipe 36 at the same point. Blocking.

According to the embodiment, the power device 104 will be described in detail below. The power device 104 includes a power cavity 22 disposed in the base cavity 12 and located on the right side of the diversion cavity 16, and a rear inner wall of the power cavity 22. A forwardly extending motor shaft 42 is rotatably connected to the motor shaft 42, and a motor 44 fixedly connected to the inner wall on the rear side of the power chamber 22 is connected to the motor shaft 42. An air pump is fixedly connected to the inner wall on the front side of the power chamber 22. 34. An electromagnet 15 is fixedly connected to the rear end surface of the air pump 34. An air pump shaft 37 extending rearwardly into the power chamber 22 is rotatably connected to the air pump 34, and the air pump shaft 37 penetrates the electromagnetic Iron 15, a spline wheel 39 is fixedly connected to the air pump shaft 37, a spline cylinder 40 is splined to the spline wheel 39, and the spline cylinder 40 is provided in front of the spline wheel 39 On the side cavity 38, a secondary compression spring 72 is connected between the spline cylinder 40 and the electromagnet 15, and a rear end surface of the spline cylinder 40 is fixedly connected to a rear side of the spline wheel 39. Bevel gear 41, the motor shaft 42 extends into the spline barrel 40 and is connected to the bevel gear 41 in a sliding manner An air pipe 23 is connected between the air pump 34 and the impeller 46, and an auxiliary air pipe 35 is connected between the air pump 34 and the air cavity 64, and the motor shaft 42 is driven to rotate by the motor 44. The motor shaft 42 drives the bevel gear 41 to rotate through a sliding key connection, so that the spline cylinder 40 and the air pump shaft 37 can be driven, so that the air pump 34 works to generate airflow and is realized as the impeller 46 and the air compressor. The auxiliary impeller 55 provides power.

According to the embodiment, the compression device 105 will be described in detail below. The compression device 105 includes a boss 45 fixedly connected to the inner wall of the rear side of the power chamber 22 and located on the right side of the motor 44. A gear shaft 33 extending left and right and extending to the right outside the end face of the boss 45 is rotatably connected to the side end surface, and a secondary bevel gear 43 fixedly connected to the bevel gear 41 is connected to the gear shaft 33, and The auxiliary bevel gear 43 is located on the left side of the boss 45, and a reduction box 27 on the right side of the boss 45 is fixedly connected to the inner wall of the rear side of the power cavity 22, and the gear shaft 33 extends to the reduction gear. The reduction box 27 can be driven in the box 27. The reduction box 27 is rotatably connected with a reduction shaft 26 extending to the right into the power chamber 22, and the reduction shaft 26 is located in front of the gear shaft 33. On the other hand, deceleration through the reduction box 27 can increase the torque of the gear 25, thereby increasing the pressing force of the rack 24 and the pressure plate 28, and increasing the compression ratio. The reduction shaft 26 is fixedly connected to The gear 25 in the power cavity 22 slides on the right inner wall of the power cavity 22 A rack 24 meshed with the gear 25 is connected, a compression chamber 30 located in the lower side of the power chamber 22 and communicating with the flow guiding chamber 16 is provided in the base chamber 12, and the compression chamber 30 opening faces to the right, a box door 29 is rotatably connected to the right opening of the compression cavity 30, the rack 24 extends downward into the compression cavity 30, and the rack 24 is fixedly connected to the compression The pressure plate 28 in the cavity 30 is rotated by the gear 25 to move the rack 24 downward, and the rack 24 drives the pressure plate 28 to move downward to compress the cutting waste.

The following describes in detail the use steps of a cutting waste recycling device of a CNC machine tool in this article with reference to FIGS. 1 to 5:

At the beginning, the cut-off block 52 is located at the upper limit, so that the gas pipe 50 communicates with the left opening of the valve body cavity 74, the gas pipe 50 is not communicated with the air pipe 53, the opening of the collection box 19 faces upward, and the cam 47 is not connected with the limit lever 61 The abutment, the sliding plug 65 is located at the lower limit by the return spring 67, the sealing block 68 does not block the upper opening of the connecting pipe 36, the pressure plate 28 is located at the upper limit, the electromagnet 15 is energized to attract the spline cylinder 40, and the cone The gear 41 is located at the rear limit position. The bevel gear 41 is disengaged from the auxiliary bevel gear 43. The spline wheel 39 is splined to the spline cylinder 40.

During work, the cutting waste generated by cutting is stored on the collection box 19, and most of the cutting waste liquid is conveyed into the connecting pipe 36 through the collecting box 19 and the diversion chamber 16, and is transferred into the waste liquid chamber 14 through the connecting pipe 36. Part of the cutting waste liquid is sent to the waste liquid cavity 14 through the compression cavity 30, the filter plate 31, and the guide pipe 32 for storage. When the machine body 69 finishes processing, the motor 44 is started, the motor 44 drives the motor shaft 42 to rotate, and the motor shaft 42 passes The feather key connection drives the bevel gear 41 to rotate. The bevel gear 41 drives the air pump shaft 37 to rotate through the spline connection of the spline cylinder 40 and the spline wheel 39. The air pump shaft 37 drives the air pump 34 to generate air flow, and part of the air flow is delivered to the auxiliary air pipe 35 to In the air cavity 64, the sliding plug 65 is pushed up. The sliding plug 65 drives the sealing block 68 up through the push rod 66 to block the upper opening of the connecting pipe 36. At the same time, the remaining air is delivered to the impeller 46 through the air pipe 23. The impeller 46 drives the rotating shaft 18 and the cam 47 to rotate, and the air flow in the impeller 46 is exhausted through the left side opening of the air pipe 50 and the valve body cavity 74. When the cam 47 rotates down to 180 degrees, it is connected with the limit lever. 61 abut stop rotation, while the collection box 19 will cut The waste is thrown into the guide cavity 16, while the cam 47 drives the push block 48 and the driven rod 60 to move downward, so that the cut-off block 52 moves downward to block the opening on the left side of the valve body cavity 74, and the air pipe 50 communicates with the air pipe 53 and the impeller The air flow in the machine 46 is conveyed into the air duct 53 through the air pipe 50 and the valve body cavity 74. The air flows into the auxiliary turbine 55 to drive the crank shaft 56 to rotate. The crank shaft 56 drives the fixed block 59 and the lifting block 21 through the crank 57 and the connecting rod 58 Moving up and down can drive the collecting box 19 to vibrate up and down to fully place the cutting waste on the collecting box 19 into the diversion cavity 16, and then the cutting waste in the diversion cavity 16 is conveyed into the compression cavity 30 through the diversion cavity 16 and thereafter The motor 44 is reversed, so that the collection box 19 is reversed and reset, so that the slide 65 is reset by the reset spring 67, and then the electromagnet 15 is de-energized. Under the elastic force of the auxiliary compression spring 72, the spline cylinder 40 moves backward. The spline wheel 39 is located in the cavity 38, the spline wheel 39 is disconnected from the spline cylinder 40, the bevel gear 41 is meshed with the auxiliary bevel gear 43, the air pump 34 stops working, and the motor shaft 42 drives the cone through the sliding key connection The gear 41 rotates, and the bevel gear 41 is meshed The connection drives the secondary bevel gear 43 and the gear shaft 33 to rotate. The gear shaft 33 drives the reduction box 27 to work and the reduction shaft 26 rotates to drive the gear 25. The gear 25 drives the rack 24 to move downward through the meshing connection, and the rack 24 drives the pressure plate 28 under. The cutting waste is compressed, and then the motor 44 is reversed to reset the rack 24 to move upward, and then the motor 44 is stopped to complete a processing waste recycling process.

The beneficial effect of the present invention is that the recovery device of the present invention adopts a recovery tank structure and is arranged on the base of the machine tool, which prevents the recovery mechanism from being installed on the machine tool table and affects the normal processing of the machine tool. It is filtered and stored in the waste liquid tank. After the machine tool finishes processing, the rotating mechanism can get the recovery tank to rotate 180 degrees, convey the cutting waste in the recovery tank to the compression chamber, and simultaneously drive the recovery tank to vibrate up and down through the vibration mechanism. The cutting waste stuck on the recovery tank is poured into the compression cavity, reducing the probability of clogging the filter of the recovery tank, thereby reducing the number of maintenance of the recovery device, and then the compression mechanism compresses the cutting waste to complete a recovery process, so The invention avoids affecting the normal processing of the machine tool through the structure of the recovery groove provided on the base of the machine tool, and can realize automatic recovery and processing of processing waste.

In the above manner, those skilled in the art can make various changes according to the working mode within the scope of the present invention.

1. A device using X-rays for security detection includes a fuselage and a detection cavity provided in the fuselage and connected to the left and right sides of the fuselage. A power receiving ring is provided at the middle position of the rotating frame, a sliding groove is provided in the four brackets provided on the rotating frame, and a power receiving pole is slidably arranged in the sliding groove. A first spring is provided between the sliding groove wall bodies, and an electrical wire is electrically connected between the electric pole and the electric ring, and an X-ray generator (not shown) is disposed in the front end wall of the lower left corner.). An X-ray imager that generates X-rays due to receiving an X-ray generator (not shown) is provided in the rear end wall of the lower left corner of the detection cavity, and the left end wall and the bottom wall of the detection cavity are provided with A contact that cooperates with the power pole, and a controller that controls the activation of the X-ray generator (not shown) is provided between the two contacts, and when the two contacts are connected to the power at the same time When the lever abuts, the controller controls the X-ray generator (not shown) to illuminate the lower left corner of the detection cavity. Once shot, at this time, the X-ray imager receives an X-ray to form an image for security personnel to inspect. The inspected items move downward with the rotation of the turret, and are set from the inside of the right end wall of the detection cavity. The exit is moved above the conveying device provided in the fuselage, and the conveyor belt provided in the transmission device is rotated to move the inspected equipment out of the equipment; a rotatable seal door is provided at the left entrance of the detection cavity, and the seal door can be opened only when both of the contacts are in contact with the power pole. The turret is not rotating; a lifting device for lifting heavy objects is provided on the left side of the fuselage, and the lifting device drives the support plate provided on the left side of the fuselage to move up and down to move the weight from a lower position to the detection cavity. The entrance set on the left.

2. The device for detecting security by using X-rays according to claim 1, wherein the transmission device comprises a transmission cavity provided in the fuselage, and a left-right symmetrical first section is rotatably disposed in the transmission cavity. A rotating shaft, the outer surfaces of the left and right two first rotating shafts are fixedly provided with a transmission wheel driven by the conveyor belt, and the rear end of the first rotating shaft on the left side extends into the rear end wall of the detection cavity. A first gear is fixedly disposed at the end of the first rotating shaft in the engaging cavity, and a second rotating shaft fixedly connected to the rotating frame is rotatably provided between the rotating frame and the engaging cavity. A second gear meshing with the first gear is fixedly provided at the end of the second rotating shaft in the meshing cavity, and the front end of the first rotating shaft on the left side extends into the front end wall of the conveying cavity. A third gear is fixedly disposed in the transmission cavity and at the end.

3. The apparatus for security detection using X-rays according to claim 1, characterized in that: the sealed door is hingedly connected to the top wall of the detection cavity, and a driving force is provided between the sealed door and the hinge shaft. A torsion spring for automatic reset of a sealed door, a groove is provided in the right end wall of the fuselage, a sliding hole with an upward opening is provided in the bottom wall of the groove, and a top end extension is slidably provided in the sliding hole. Into a lock groove provided in the bottom wall of the sealed door, an electromagnet matching the lock lever is provided in the bottom wall of the sliding hole, and a second spring is provided between the lock lever and the electromagnet. An inductor that senses the sealed door is disposed in the right end wall of the groove.

4. The device for detecting security by using X-rays according to claim 1, wherein the lifting device comprises a third rotating shaft that is rotatably disposed on the left side of the fuselage, and an outer surface of the third rotating shaft is fixed with a swing. A lever, the swing lever is articulatedly connected to the bottom wall of the support plate at an end far away from the third rotation shaft, and the support plate is articulated with a front-rear symmetrical hinge rod, and the hinge rod is far from the support The end of one side of the plate is rotatably connected to the end wall of the fuselage. A rotation cavity is provided in the bottom wall of the transfer cavity, and a left end wall of the rotation cavity is rotatably provided with an outer surface of the third rotation shaft. A worm gear meshed with a worm gear, a first bevel gear is fixedly disposed at the end of the worm in the rotation cavity, and a fourth rotation shaft is rotatably disposed between the rotation cavity and the transmission cavity, and the first A second bevel gear meshing with the first bevel gear is fixedly disposed at the end of the four rotation shafts, and a fourth gear is fixedly disposed at the end of the fourth rotation shaft in the transmission cavity.

5. The device for detecting security by using X-rays according to claim 1, characterized in that: a sliding cavity with an opening forward is provided in the rear end wall of the transmission cavity, and a slide is slidably provided in the sliding cavity Block, a driving motor is fixedly arranged in the front end wall of the sliding block, a fifth gear meshing with the third gear is fixedly arranged at the end of the output shaft of the driving motor, and the top wall of the sliding cavity is provided with The sensor is electrically connected with the electric push rod.
